(19) United States
(12) Patent Application Publication
(10) Pub. No.: US 2024/0405305 A1
(43) Pub. Date: Dec. 5, 2024

(54) PROCESS

(71) Applicant: CYCLADEX LTD., London (GB)

(72) Inventor: Roger B. PETTMAN, Winter Park, FL (US)

(21) Appl. No.: 18/698,165

(22) PCT Filed: Oct. 5, 2022
(86) PCT No.: PCT/GB2022/052519

§ 371 Date: Apr. 3, 2024

Related U.S. Application Data
(60) Provisional application No. 63/252,823, filed on Oct. 6, 2021.

(51) Int. Cl. H01M 10/54; C22B 5/00; C22B 7/00; C22B 26/12

(52) U.S. Cl. CPC H01M 10/54; C22B 5/00; C22B 7/008; C22B 26/12

(57) ABSTRACT

Disclosed herein is a method of extracting lithium from a lithium bearing material comprising the steps of: a) providing an aqueous oxidant mixture comprising water, an oxidising means, and a source of halide ion; b) contacting the aqueous oxidant mixture with the lithium bearing material to extract the lithium from the lithium bearing material and form a lithium halide solution.

### FIELD OF THE INVENTION

The present invention relates to methods of extracting lithium from a lithium bearing material.

### BACKGROUND OF THE INVENTION

Lithium and lithium salts have a variety of different uses and applications. In recent years, there has been a significant increase in the demand for lithium and its salts, at least partially attributable to the increase in the use of batteries. This increase in demand has created a desire to efficiently extract lithium from lithium bearing materials.

Extraction processes for other metals are known in the art. For example, methods of extracting precious metals (such as gold or silver) are known. Generally, such methods involve extracting precious metal from the precious metal bearing material (usually referred to as the “leaching” of precious metal from the precious metal bearing material) and then capturing the leached precious metal from the solution. For example, some methods use highly poisonous inorganic cyanides to extract the precious metal from the precious metal bearing material. Such processes are associated with considerable environmental concerns (where accidental leakages can result in environmental contamination) as well as considerable health and safety concerns (where inadvertent cyanide exposure can cause notable human health concerns).

Other methods for extracting precious metals are disclosed in WO 2017/158561 and WO2014/172667. However, these methods have been used only for extracting what are generally referred to as precious metals (such as gold and/or silver, amongst others such as platinum and palladium). Meanwhile, lithium is a metal of a different nature, evident from its contrasting location in the periodic table.

Methods of extracting lithium from lithium bearing materials are also known. However, existing extraction processes for lithium ordinarily involve the use of high pressures and elevated temperatures. Such conditions lack convenience, are costly in terms of capital investment, high in terms of operating costs and associated carbon footprint, and typically do not possess environmentally friendly credentials.

Accordingly, there remains a need for new methods of extracting lithium from a lithium bearing material.

### SUMMARY OF THE INVENTION

In a first aspect there is a method of extracting lithium from a lithium bearing material comprising the steps of:
a) providing an aqueous oxidant mixture comprising water, an oxidising means, and a source of halide ion,
b) contacting the aqueous oxidant mixture with the lithium bearing material to extract the lithium from the lithium bearing material and form a lithium halide solution.

It has been surprisingly found that, when applied to a lithium bearing material, the aqueous oxidant mixture disclosed herein is particularly effective at extracting lithium. Although the method is compatible with high temperatures and pressures, such high temperatures and pressures need not be employed for the method disclosed herein to be effective. As such, the method disclosed herein provides an effective means to extract lithium, without necessarily having to resort to the high temperatures and pressures such as those featuring in lithium extraction processes of the prior art. The result is an effective, convenient, and more environmentally friendly lithium extraction process than the prior art. The lithium is extracted to form a lithium halide, which may then be isolated, or it may be converted into other forms of lithium.

### DETAILED DESCRIPTION

Used throughout, the language “up to” means “up to an including”.

The lithium bearing material can take various forms, as will be appreciated by the skilled person. The lithium bearing material can, for example, be selected from an ore (a naturally occurring rock or sediment), including a concentrate of such ore, sea water, subsurface brines, waste material, a metal mixture, a human body component, a medical device, or a consumer product.

Examples of an ore include mineral deposits (such as mineral veins) and the like obtained from waterways, causeways, mines, and other Earth-bound sources known in the art. Preferred examples of an ore include an ore of petalite (LiAl(Si₂O₅)₂, an ore of lepidolite K(Li,Al)₃(Al,Si,Rb)₄O₁₀(F,OH)₂, an ore of spodumene LiAl(SiO₃)₂ or a combination thereof. Examples of a human body component include teeth, bones, heart, muscle, joints, legs, arms, hands, fingers, knees, feet, among others. Examples of medical devices include life support systems and devices, such as a diagnostic machine, a dialysis machine, a medical implant (for example, a pacemaker), a tooth filling, tooth enamel, tooth inlay, dentures, an artificial joint, an artificial limb or other artificial appendage, or materials removed after diagnostic, radiodiagnostic or therapeutic administration that comprise e.g. metal-containing nanoparticles. Examples of consumer products include a jewellery item, an electronics item, and other metal products such as an ingot, bar or currency coin. Examples of a jewellery item include a ring, a bracelet and a necklace, among others. Examples of an electronics item include a computer, a monitor, a power supply, an amplifier, a preamplifier, a digital to analog converter, an analog to digital converter, a lithium battery, and a phone, among others. Examples of waste material includes tailings from previous mining efforts, bio-waste, and waste derived from sewer plants.

Various examples of lithium bearing material are disclosed herein. In some instances, the lithium bearing material may fall into a generic class of materials—in such instances, it will be appreciated that lithium may not be contained in all materials in the generic class. For example, the lithium bearing material can, for example, be an ore (a naturally occurring rock or sediment)—however not all ores contain lithium. The skilled person will appreciate and be able to determine whether and when a particular material constitutes a lithium bearing material.

The skilled person will appreciate that the lithium bearing material may contain various levels of lithium, depending on the type of lithium bearing material. The methods disclosed herein are effective at a variety of levels. For example, the lithium bearing material may comprise the lithium in an amount ranging from 0.001 to 15% by weight. The lithium bearing material may comprise lithium in levels of at least 0.001% by weight, at least 0.01% by weight, or at least 0.05% by weight. The lithium bearing material may comprise lithium in levels of up to 15% by weight, up to 12% by weight, or up to 10% by weight. The lithium contained in the lithium bearing material may be in the form of one or more lithium salts.

Preferably, the lithium bearing material is an ore (i.e. an ore that contains lithium) a subsurface brine, a lithium battery, or a combination thereof. More preferably, the lithium bearing material is an ore of petalite (LiAl(Si₂O₅)₂, an ore of lepidolite K(Li,Al)₃(Al,Si,Rb)₄O₁₀(F,OH)₂, an ore of spodumene LiAl(SiO₃)₂, a subsurface brine, a lithium battery, or a combination thereof.

Preferably, the lithium bearing material is a lithium battery, in particular a spent or partially spent lithium battery. In such scenarios, the method disclosed herein provides an effective means of recycling spent or partially spent lithium batteries. As such, the method disclosed herein provides a surprising new means to recycle lithium batteries. By applying the method disclosed herein to a lithium battery, in particular a spent or partially spent lithium battery, lithium halide can be extracted and used for a variety of different industrial purposes. It will be appreciated that “spent or partially spent” is used to refer to batteries that have been fully or partially used for a particular purpose.

Preferably, the lithium bearing material is an ore (i.e. an ore that contains lithium). More preferably, the the lithium bearing material is an ore containing lithium at a level of 0.001 to 15% by weight, preferably 0.05 to 10% by weight.

As will be appreciated by the skilled person, an ore may be subjected to preliminary steps such as reducing the size of its particles and/or agglomerating particles to provide controlled size agglomerates. The ore may be reduced in size so as to be processable as fluid slurry, and brought into contact with the oxidant mixture in vats. The ore may also be subjected to pre-treatment in a pressure oxidative system which can involve heating to a temperature from 200° C. to 2000° C., but more typically to a temperature from 600° C. to 1300° C.

Disclosed herein, there is the step of providing an aqueous oxidant mixture comprising water, an oxidising means, and a source of halide ion. This is denoted herein as step a). In step a), without wishing to be bound by theory, it is thought that the oxidising means interacts with the halide ion to form halide species such as [Hal]OH (where [Hal] is a halide).

Disclosed herein, the “aqueous oxidant mixture” refers to the mixture formed when combining the water, oxidising means, and a source of halide ion.

The water present may be tap water, well water distilled water, or sea water.

It will be understood that the “oxidising means” is a component capable of acting as an oxidant, and can for example be a chemical reagent (usually referred to as an oxidising agent), or a component of a system suitable for achieving oxidation by electrolysis, for example an anode connected to a power source. Preferably, the oxidising means is a chemical reagent.

Preferably, the oxidising means is hydrogen peroxide, ozone, oxygen, chlorine, bromine, iodine, hypochlorous acid, hypobromous acid, hypoiodous acid, a hypochlorite salt, a hypobromite salt, a hypoiodite salt, a permanganate salt, an anode connected to a power source, or a combination thereof. The use of these oxidants results in a more environmentally friendly process with fewer health and safety concerns.

Preferably, the oxidising means is hydrogen peroxide, ozone, oxygen, chlorine, bromine, iodine, hypochlorous acid, hypobromous acid, hypoiodous acid, a hypochlorite salt, a hypobromite salt, a hypoiodite salt, a permanganate salt, or a combination thereof.

Preferably, the oxidising means is hydrogen peroxide, ozone, oxygen, chlorine, hypochlorous acid, hypobromous acid, a hypochlorite salt, a hypobromite salt, a hypoiodite salt, a permanganate salt, or a combination thereof.

More preferably, the oxidising means is hydrogen peroxide, ozone, chlorine, hypochlorous acid, hypobromous acid, a hypochlorite salt, a permanganate salt or a combination thereof.

More preferably, the oxidising means is hydrogen peroxide, ozone, chlorine, hypochlorous acid, a hypochlorite salt, a permanganate salt or a combination thereof.

Yet more preferably, the oxidising means is hydrogen peroxide and/or ozone. Particularly preferably, the oxidising means is hydrogen peroxide.

Particularly good results have been achieved when using hydrogen peroxide as the oxidising means.

When the oxidising means is a chemical reagent (such as hydrogen peroxide, ozone, oxygen, chlorine, bromine, iodine, hypochlorous acid, hypobromous acid, hypoiodous acid, a hypochlorite salt, a hypobromite salt, a hypoiodiate salt, a permanganate salt, or a combination thereof) the chemical reagent can be used in various amounts to form the aqueous oxidant mixture.

Preferably, when the oxidising means is a chemical reagent (such as hydrogen peroxide, ozone, oxygen, chlorine, bromine, iodine, hypochlorous acid, hypobromous acid, hypoiodous acid, a hypochlorite salt, a hypobromite salt, a hypoiodiate salt, a permanganate salt, or a combination thereof), the amount of oxidising means added to form the aqueous oxidant mixture relative to the amount of the source of the halide ion added to form the aqueous oxidant mixture is in the range of 0.1:1 to 10:1 by weight, more preferably in the range of 1:1 to 10:1 by weight.

The skilled person will appreciate that “ozone” refers to O₃. Ozone can be introduced as a gas by bubbling through the remaining components to form the aqueous oxidant mixture. Ozone can be generated in situ by a variety of possible methods, as will be appreciated by the skilled person The skilled person will appreciate that “chlorine” refers to Cl₂. Chlorine can be introduced as a gas by bubbling through the remaining components to form the aqueous oxidant mixture. Chlorine can be generated in situ by a variety of possible methods, as will be appreciated by the skilled person.

The skilled person will appreciate that “oxygen” refers to O₂. Oxygen can be introduced as a gas by bubbling through the remaining components to form the aqueous oxidant mixture. Oxygen can be generated in situ by a variety of possible methods, as will be appreciated by the skilled person.

The skilled person will appreciate that “bromine” refers to Br₂. Bromine can be introduced as a liquid or a gas. For example, bromide may be provided for use in the process as part of an aqueous solution which can vary in concentration, possible concentrations being 5-100 wt. %, 5-70 wt. %, 20-70 wt. %, 30-70 wt. %, or 30-60 wt. %. Bromide can be introduced as a gas by bubbling through the remaining components to form the aqueous oxidant mixture, where the bromide is generated in situ by a variety of possible methods, as will be appreciated by the skilled person.

The skilled person will appreciate that “iodine” refers to 1₂. Iodine may be added directly as a solid to form the aqueous oxidant mixture, or, it may be provided for use in the process as part of an aqueous solution which can vary in concentration, possible concentrations being 5-100 wt. %, 5-70 wt. %, 20-70 wt. %, 30-70 wt. %, or 30-60 wt. %.

The skilled person will appreciate that “hypochlorous acid” refers to HOCl. This may be provided for use in the process as part of an aqueous solution which can vary in concentration, possible concentrations being 5-100 wt. %, 5-70 wt. %, 20-70 wt. %, 30-70 wt. %, or 30-60 wt. %.

The skilled person will appreciate that “hypobromous acid” refers to HOBr. This may be provided for use in the process as part of an aqueous solution which can vary in concentration, possible concentrations being 5-100 wt. %, 5-70 wt. %, 20-70 wt. %, 30-70 wt. %, or 30-60 wt. %.

The skilled person will appreciate that “hypoiodous acid” refers to HlO. This may be provided for use in the process as part of an aqueous solution which can vary in concentration, possible concentrations being 5-100 wt. %, 5-70 wt. %, 20-70 wt. %, 30-70 wt. %, or 30-60 wt. %.

The skilled person will appreciate that “hypochlorite salt” refers to any salt capable of generating the hypochlorite anion (ClO⁻) in solution. Preferably, the hypochlorite salt is an alkali metal hypochlorite salt e.g. lithium hypochlorite, potassium hypochlorite, and/or sodium hypochlorite. Preferably, the hypochlorite salt is sodium hypochlorite.

The skilled person will appreciate that “hypobromite salt” refers to any salt capable of generating the hypobromite anion (BrO⁻) in solution. Preferably, the hypobromite salt is an alkali metal hypobromite salt e.g. lithium hypobromite, potassium hypobromite, and/or sodium hypobromite. Preferably, the hypobromite salt is sodium hypobromite.

The skilled person will appreciate that hypoiodite salt refers to any salt capable of generating the hypoiodite anion (IO⁻) in solution. Preferably, the hypoiodite salt is an alkali metal hypoiodite salt e.g. lithium hypoiodite, potassium hypoiodite, and/or sodium hypoiodite. Preferably, the hypoiodite salt is sodium hypoiodite.

The skilled person will appreciate that “permanganate salt” refers to any salt capable of generating the permanganate anion (MnO₄) in solution. Preferably, the permanganate salt is an alkali metal permanganate salt e.g. lithium permanganate, potassium permanganate, and/or sodium permanganate. Preferably, the permanganate salt is potassium permanganate.

The skilled person will appreciate that an anode is an electrode at which oxidation occurs. Generally, the anode is at least partially (or, fully) submerged in the aqueous oxidant mixture. The anode is connected to a power source which is capable of applying an electrical current such that the electrons flow away from the anode, thereby allowing oxidation (i.e. loss of electrons) to occur at the anode. This is generally referred to as oxidation by electrolysis, and so the skilled person will appreciate that the power source will in turn usually be connected to a cathode.

The skilled person will appreciate that “hydrogen peroxide” refers to H₂O₂. The use of hydrogen peroxide provides an economic, commercial and environmental preference to other oxidants. More specifically, hydrogen peroxide is available commercially at very large scale and the breakdown products are water and oxygen, resulting in environmentally friendly credentials.

Various amounts of hydrogen peroxide may be used to form the aqueous oxidant mixture. Preferably, the amount of hydrogen peroxide added to form the aqueous oxidant mixture relative to the amount of the source of the halide ion added to form the aqueous oxidant mixture is in the range of 0.1:1 to 10:1 by weight, more preferably in the range of 1:1 to 10:1 by weight.

Hydrogen peroxide may be provided for use in the process as part of an aqueous solution which can vary in concentration, possible concentrations being 5-100 wt. %, 5-70 wt. %, 20-70 wt. %, 30-70 wt. %, or 30-60 wt. %.

Hydrogen peroxide is available from many companies on a commercial basis and can be supplied at large scale by road or rail. These companies include but are not limited to PeroxyChem, Solvay GmbH, Kemira, Arkema. Some companies offer the concept of on site generation, which may be compatible with the method disclosed herein.

The inventors of the present application have found that the source of the halide ion can take a variety of different possible forms and still result in successful lithium extraction. The source of the halide ion may be supplied as a liquid (such as an aqueous solution or dispersion), a solid, or a gas. The source of the halide ion can for example be generated from a halide gas (e.g. when generating a source of chloride ion), a halide gas/liquid (e.g. when generating a source of bromide ion) or a halide solid/liquid (e.g. when generating a source of iodide ion).

The inventors of the present application have found that the source of halide ion can be a variety of different possible halides and still result in successful lithium extraction. Preferably however, the source of the halide ion is a source of bromide ion, a source of chloride ion, a source of iodide ion, or a combination thereof. More preferably, the source of halide ion is a source of bromide ion, a source of chloride ion, or a combination thereof, as such scenarios result in particularly good extraction. In some scenarios, the source of halide ion may be at least one source of bromide ion.

The source of halide ion can be a halide salt. Preferably, the source of halide ion is at least one metal halide. When the source of halide ion is at least one metal halide, the metal can be lithium, potassium, sodium, calcium, or a combination thereof.

More preferably, the source of halide ion is at least one alkali metal halide. When the source of halide ion is at least one alkali metal halide, said alkali metal can be lithium, potassium, sodium, or a combination thereof. In a preferred scenario, the source of the halide ion is sodium halide and/or potassium halide, particularly when the halide is bromide.

Various amounts of the source of halide ion may be used to form the aqueous oxidant mixture. The amount of the source of halide ion added to form the aqueous oxidant mixture can for example range from 1 to 20 wt. % based on the total weight of the aqueous oxidant mixture. The amount of the source of halide ion added to form the aqueous oxidant mixture can be at least 1 wt. %, preferably at least 5 wt. % based on the total weight of the aqueous oxidant mixture. The amount of the source of halide ion added to form the aqueous oxidant mixture can be up to 20 wt. %, preferably up to 15 wt. % based on the total weight of the aqueous oxidant mixture.

It has been found that the aqueous oxidant mixture can take a variety of different pH values and still effectively extract lithium from the lithium bearing material. The skilled person will appreciate how to tailor the aqueous oxidant mixture so as to achieve a particular pH. The pH is measured by standard methods known in the art, for example using a standard electronic pH meter or colour coded test strip, across temperatures ranging from 5° C. to 75° C. For example, the pH can be between 0.1-14.

The aqueous oxidant mixture may have a pH of 0-7, and so generally be in the acidic or neutral end of the pH spectrum. In these scenarios, the pH may be at least 0.8, at least 0.1, or even at least 1. The pH may be up to 6, preferably up to 5, more preferably up to 3, or even up to 2.

The aqueous oxidant mixture may further comprise an acid. The acid can for example be sulphuric acid, nitric acid, hydrochloric acid, acetic acid, carbonic acid, formic acid, or a combination thereof. Preferably, the acid is sulphuric acid and/or nitric acid. The acid may be added as a concentrated acid or as a dilute solution. The skilled person will also appreciate that carbonic acid, for example, may be added directly to the aqueous oxidant mixture, or, it may be formed in-situ by the addition of carbon dioxide. When acid features in the aqueous oxidant mixture, the preferred order of addition to form the aqueous oxidant mixture is to add the acid after the remaining components. In other words, the preferred order of addition is to first combine the oxidising means and the source of the halide ion to form an oxidant-halide mixture, and then add the acid to the oxidant-halide mixture to form the aqueous oxidant mixture. The term “oxidant-halide mixture” refers to the mixture formed from combining the oxidant and the source of halide ion.

The aqueous oxidant mixture may have a pH of 7-14, and so generally be in the alkaline or neutral end of the pH spectrum, preferably 8-14, more preferably 9-14.

The aqueous oxidant mixture may further comprise an alkaline material. The alkaline material can for example be sodium hydroxide, potassium hydroxide, calcium carbonate, calcium bicarbonate, sodium carbonate, sodium bicarbonate, potassium carbonate, potassium bicarbonate, calcium oxide, sodium hypochlorite, potassium hypochlorite, or a combination thereof.

The skilled person will appreciate that the oxidising means and the source of halide ion are not necessarily mutually exclusive terms, and so may be the same or different species. For example, the oxidising means and the source of the halide ion may both be hypobromous acid (thereby providing a direct source of BrOH to the aqueous oxidant mixture). However preferably, the oxidising means and the source of halide ion are different species.

The skilled person will appreciate that the acid and the source of halide ion are not necessarily mutually exclusive terms, and so may be the same or different species. For example, the source of the halide ion and the acid may both be hypobromous acid. However preferably, the source of halide ion and the acid are different species.

The skilled person will appreciate that the acid and the oxidising means are not necessarily mutually exclusive terms, and so may be the same or different species. For example, the acid and the oxidising means may both be hypobromous acid. However preferably, the acid and the oxidising means are different species.

More preferably, all three of the oxidising means, the source of halide ion, and the acid, are different species.

The amount of lithium bearing material that contacts the aqueous oxidant mixture can be tailored depending on e.g. the type of lithium bearing material, but can for example be added in amounts of 1 g to 1000 g, preferably 10 g to 800 g, more preferably 30 g to 600 g. The ratio, by weight, of lithium bearing material:aqueous oxidant mixture can be tailored depending on e.g. the type of lithium bearing material, and the scale at which the method is being conducted, and can for example range from 1:0.2 to 1:10000. The ratio, by weight, of lithium bearing material:aqueous oxidant mixture can be at least 1:0.2, preferably at least 1:1, more preferably at least 1:2. The ratio, by weight, of lithium bearing material:aqueous oxidant mixture can be up to 1:10000, up to 1:1000, up to 1:10, preferably up to 1:8, more preferably up to 1:7.

Preferably, the aqueous oxidant mixture is stirred for at least 5 minutes before the aqueous oxidant mixture is contacted with the lithium bearing material.

Disclosed herein, there is the step of contacting the aqueous oxidant mixture with the lithium bearing material to extract the lithium from the lithium bearing material and form a lithium halide solution. Optionally following this, the same lithium bearing material may be separated from the lithium halide solution and washed, preferably with a fresh mixture of the aqueous oxidant mixture disclosed herein. In the instance that the lithium bearing material is washed with a fresh mixture of the aqueous oxidant mixture disclosed herein, this will form additional lithium halide solution.

Disclosed herein, there is the step of contacting the aqueous oxidant mixture with the lithium bearing material to extract the lithium from the lithium bearing material and form a lithium halide solution. As used herein, the extraction of the lithium from the lithium bearing material can be referred to as the leaching of the lithium from the lithium bearing material. The lithium is extracted from the lithium bearing material to form a lithium halide, which may then be isolated, or it may be converted into other forms of lithium. For example, the lithium halide may be converted to another lithium salt (such as lithium carbonate, and/or lithium hydroxide), lithium metal (lithium metal referring to Li°, as opposed to Li⁺), or a combination thereof. Accordingly, the method may further comprise the step of converting the lithium halide extracted by way of step a) to another lithium salt and/or lithium metal. The step of converting the lithium halide to another lithium salt and/or lithium metal is denoted herein as step c). The skilled person will appreciate that there are various ways in which to convert the lithium halide to another lithium salt and/or lithium metal and will be familiar with appropriate reagents and conditions.

Preferably, the lithium halide is converted to lithium metal, lithium carbonate, and/or lithium hydroxide. Accordingly, the method preferably further comprises the step of converting the lithium halide extracted by way of step a) to lithium metal, lithium carbonate, and/or lithium hydroxide. The skilled person will appreciate that there are various ways in which to convert the lithium halide to lithium metal, lithium carbonate, and/or lithium hydroxide and will be familiar with appropriate reagents and conditions. However, preferably step c) comprises the step of contacting the lithium halide solution with carbon dioxide, carbon monoxide, sodium carbonate, potassium carbonate, sodium bicarbonate, potassium bicarbonate, carbonic acid, a reducing means, sodium hydroxide, potassium hydroxide, oxygen, ozone, or a combination thereof.

A further benefit is provided when the method comprises the step of converting the lithium halide extracted by way of step a) to another lithium salt, such as lithium carbonate, and/or lithium hydroxide. Doing so allows the halide to effectively be recycled. This therefore allows for an efficient process at least in terms of use of reactants.

When step c) comprises the step of contacting the lithium halide solution with carbon dioxide, carbon monoxide, sodium carbonate, potassium carbonate, sodium bicarbonate, potassium bicarbonate, carbonic acid, or a combination thereof, the lithium halide is thereby converted to lithium carbonate.

When step c) comprises the step of contacting the lithium halide solution with a reducing means, the lithium halide is thereby converted to lithium metal.

When step c) comprises the step of contacting the lithium halide solution with sodium hydroxide, potassium hydroxide, oxygen, ozone, or a combination thereof, the lithium halide is converted to lithium hydroxide.

The skilled person will appreciate that a reducing means is a component capable of acting as an reductant, and can for example be a chemical reagent (usually referred to as an reducing agent), or a component of a system suitable for achieving reduction by electrolysis, for example a cathode connected to a power source. Preferably, the reducing means is a chemical reagent.

Preferably, the reducing means is zinc, sodium metabisulfite, hydrogen gas, and/or a cathode connected to a power source. The skilled person will appreciate that a cathode is an electrode at which reduction occurs. Generally, the cathode is at least partially (or, fully) submerged in the lithium halide solution.

The cathode is connected to a power source which is capable of applying an electrical current such that the electrons flow towards the cathode, thereby allowing reduction (i.e. gain of electrons) to occur at the cathode. This is generally referred to as reduction by electrolysis, and so the skilled person will appreciate that the power source will in turn usually be connected to an anode.

More preferably, the reducing means is zinc, sodium metabisulfite, and/or hydrogen gas.

Preferably, the lithium halide is converted to lithium carbonate, as in this scenario the overall reaction results in consumption of carbon dioxide, resulting in yet further improved environmental credentials.

Disclosed herein, lithium is extracted from the lithium bearing material to form a lithium halide, which may be recovered and so isolated from the remaining reactants, and/or it may be converted into other forms of lithium, which may then in turn be recovered and so isolated from the remaining reactants. Accordingly, the methods disclosed herein may further comprise the step of recovering the lithium halide and/or may further comprise the step of recovering the other form(s) of lithium to which the lithium halide has been converted. It will be understood that by “recovering” it is meant that the lithium species in question (i.e. the lithium halide, and/or the other form(s) of lithium to which the lithium halide has been converted) is collected, removed, or isolated, from the reactant mix. This may be achieved by appropriate solid-liquid separation techniques (such as sieving, for example) when the lithium species in question is solid (such as lithium carbonate), by reverse osmosis, by the use of activated carbon, or by use of one or more ion exchange resins. It will be understood that the “other form(s) of lithium to which the lithium halide has been converted” refers to those detailed elsewhere in the present disclosure and so can include another lithium salt (such as lithium carbonate, and/or lithium hydroxide), lithium metal (lithium metal referring to Li°, as opposed to Li⁺), or a combination thereof, and are subject to the same degrees of preference to those detailed herein.

The use of ion exchange resins is a preferred means by which to recover the lithium species i.e. the lithium halide, and/or the other form(s) of lithium to which the lithium halide has been converted. As detailed elsewhere in this disclosure, such other form(s) of lithium can include another lithium salt (such as lithium carbonate, and/or lithium hydroxide), lithium metal, or a combination thereof. Accordingly, step b) and (when present) step c) may feature the use of resins. Ion exchange resins capture the lithium species so as to isolate the lithium species from the solution, allowing good recovery of the lithium species from the reactant mix. The ion exchange resins may be used in the process disclosed herein together with lithium bearing materials that contain lithium at varying levels, but are effective even when the level of lithium in the lithium bearing material is low. This offers a clear advantage over using for example cyclodextrin, where the inventors of the present application made the realisation that cyclodextrin generally requires the lithium bearing material to contain above a certain level of lithium, generally above 100 ppm.

When used in the process disclosed herein, the ion exchange resins are preferably comprised of an organic polymer backbone to which a series of functional groups are attached, said functional groups containing at least one heteroatom. In this preferred scenario, the resins provide improved capture of the lithium species compared with capturing using activated carbon. Without wishing to be bound by theory, it is thought that the improved capture of the lithium species is due to the at least one heteroatom within the series of functional groups. It is thought that the at least one heteroatom coordinates with the lithium species in question, facilitating the formation of a complex between the lithium species and the resin. Such resins may therefore be referred to as chelating resins.

Step b) may further comprise contacting the aqueous oxidant mixture with a resin, said resin preferably being an ion exchange resin comprised of an organic polymer backbone to which a series of functional groups are attached, said functional groups containing at least one heteroatom. It is thought that the use of a resin in step b) allows for the formation of a lithium halide resin complex. It will be understood that the term “lithium halide resin complex” refers to the species formed from the interaction between the lithium halide (i.e. the lithium that has been extracted from the lithium bearing material) and the resin. It will be understood from this that the lithium halide resin complex refers to the resin with the lithium halide complexed thereon or therein.

In step b, the resin and the lithium bearing material may be added simultaneously, or sequentially. “Sequentially” meaning one after the other. For example, when the resin and the lithium bearing material are added to the aqueous oxidant mixture sequentially, the resin can be added before (i.e. prior to), or after, the addition of the lithium bearing material. Accordingly, the resin can be added simultaneously with, prior to, or after, the addition of the lithium bearing material. The timing of these steps can be tailored at the convenience of the processing facilities. It will be appreciated that, when the resin and lithium bearing material are added either simultaneously or in immediate succession, the lithium halide may form and then immediately react to result in the formation of the lithium halide resin complex. This scenario is referred to as a “Resin in leach” process.

As such, in step b, the resin and the lithium bearing material may be added simultaneously to the aqueous oxidant mixture. Or, in step b, the resin may be added to the aqueous oxidant mixture prior to the addition of the lithium bearing material. Or, in step b, the resin may be added to the aqueous oxidant mixture after the addition of the lithium bearing material.

The amount of resin used in step b) can vary depending on the application in question, but can for example range from 0.1-100 g per 100 ml of aqueous oxidant mixture. The amount of resin used in step b) can be at least 0.1 g, at least 1 g, at least 2 g, preferably at least 5 g, per 100 ml of aqueous oxidant mixture. The amount of resin used in step b) can be up to 100 g, up to 80 g, up to 50 g, preferably up to 20 g, per 100 ml of aqueous oxidant mixture.

Step c may further comprise contacting the lithium halide solution with a resin, said resin preferably being an ion exchange resin comprised of an organic polymer backbone to which a series of functional groups are attached, said functional groups containing at least one heteroatom. It is thought that the use of a resin in step c) allows for the formation of a complex between the resin and the form(s) of lithium to which the lithium halide has been converted. As detailed elsewhere in this disclosure, such other form(s) of lithium can include another lithium salt (such as lithium carbonate, and/or lithium hydroxide), lithium metal, or a combination thereof. For example, when the lithium halide has been converted to lithium metal, lithium carbonate, and/or lithium hydroxide, it is thought that the use of a resin in step c) allows for the formation of a lithium metal resin complex, a lithium carbonate resin complex, and/or lithium hydroxide resin complex. It will be understood that the terms “lithium metal resin complex”, “lithium carbonate resin complex”, and “lithium hydroxide resin complex” each refer to the species formed from the interaction between the respective lithium species in question and the resin. It will be understood from this that the “lithium metal resin complex”, “lithium carbonate resin complex”, and “lithium hydroxide resin complex” refers to the resin with the respective lithium species complexed thereon or therein.

In step c), the resin may be added prior to, simultaneously with, or after the conversion of the lithium halide to other form(s) of lithium. As detailed elsewhere in this disclosure, such other form(s) of lithium can include another lithium salt (such as lithium carbonate, and/or lithium hydroxide), lithium metal, or a combination thereof. The timing of these steps can be tailored at the convenience of the processing facilities. It will be appreciated that, when the addition of the resin and the conversion of the lithium halide to other form(s) of lithium occurs either simultaneously or in immediate succession, the other form(s) of lithium may form and then immediately react to result in the formation of a complex between the resin and the lithium species in question (such as, for example, a lithium metal resin complex, a lithium carbonate resin complex, and/or lithium hydroxide resin complex).

In step c), the resin is preferably added simultaneously with, or after, the conversion of the lithium halide to other form(s) of lithium. As detailed elsewhere in this disclosure, such other form(s) of lithium can include another lithium salt (such as lithium carbonate, and/or lithium hydroxide), lithium metal, or a combination thereof. More preferably, the resin is added after the conversion of the lithium halide to other form(s) of lithium—in which case, step c may further comprise contacting the mixture of other lithium form(s) of lithium with a resin, said resin preferably being an ion exchange resin comprised of an organic polymer backbone to which a series of functional groups are attached, said functional groups containing at least one heteroatom, to thereby form a complex between the resin and the lithium species in question.

The amount of resin used in step c) can vary depending on the application in question, but can for example range from 0.1-100 g per 100 ml of lithium halide solution, or mixture of other form(s) of lithium to which the lithium halide has been converted. As detailed elsewhere in this disclosure, such other form(s) of lithium can include another lithium salt (such as lithium carbonate, and/or lithium hydroxide), lithium metal, or a combination thereof. The amount of resin used in step c) can be at least 0.1 g, at least 1 g, at least 2 g, preferably at least 5 g, per 100 ml of lithium halide solution, or mixture of other form(s) of lithium to which the lithium halide has been converted. The amount of resin used in step c) can be up to 100 g, up to 80 g, up to 50 g, preferably up to 20 g, per 100 ml of lithium halide solution, or mixture of other form(s) of lithium to which the lithium halide has been converted.

The term “ion exchange resin” takes its usual definition in the art, and so refers to a material that acts as a medium for ion exchange that is generally insoluble in aqueous mediums. It will be understood from this that the ion exchange resin is substantially insoluble in the aqueous solutions and mixtures disclosed herein, e.g. the aqueous oxidant mixture, lithium halide solution or mixture of other form(s) of lithium to which the lithium halide has been converted. By “substantially insoluble”, it is meant that less than 0.1 mg/ml of the resin dissolves in the aqueous solutions and mixtures disclosed herein (e.g. the aqueous oxidant mixture, lithium halide solution or mixture of other form(s) of lithium to which the lithium halide has been converted) at 25° C.

As used herein, definitions relating to the ion exchange resin generally refer to the features of the ion exchange resin per se, i.e. prior to its addition to the aqueous solutions and mixtures disclosed herein. After its addition, it will be understood that, depending on the pH of the medium in question, protonation or deprotonation of certain groups of the ion exchange resin may occur.

The ion exchange resin is preferably a porous material. The porosity of the ion exchange resin increases the surface area available for ion exchange.

Consistent with what will be understood from the term “ion exchange resin”, the ion exchange resin, when used in the method disclosed herein, is comprised of a polymer backbone (sometimes referred to as a polymer matrix), to which a series of functional groups are attached.

Specifically, the ion exchange resin, when used, is comprised of an organic polymer backbone to which a series of functional groups are attached.

The ion exchange resin may essentially consist of an organic polymer backbone to which a series of functional groups are attached.

The ion exchange resins, when used in the method disclosed herein, are commercially available from a variety of sources, with commercially available resins including but not limited to the following, which are all ion exchange resins with polystyrene backbones functionalised with the following groups:
SEPLITE® LSC660: functionalised with guanidine groups
SEPLITE® LSC740: functionalised with thiol groups
SEPLITE® LSC710: functionalised with iminodiacetic acid groups
AMBERSEP® 21K XLT Mesh Anion Exchange Resin (Cl⁻): functionalised with quaternary ammonium groups
Purogold™ MTA5015SO4: functionalised with quaternary ammonium groups
LEWATIT® MonoPlus TP 214: functionalised with thiourea groups
Puromet™ MTS9140: functionalised with thiourea groups
LEWATIT MP 62 WS: functionalised with tertiary amine groups
LEWATIT TP 106: functionalised with quaternary ammonium groups

As used herein, the term “polymer” takes its usual definition the art and so refers to a homopolymer or copolymer formed from the polymerisation of one or more monomers. As such, this term covers e.g. linear polymers, branched polymers, and cyclic polymers.

As used herein, the term “homopolymer” takes its usual definition in the art, and so refers to a polymer whose polymer chains comprise one type of monomer. As used herein, the term “co-polymer” takes its usual definition in the art, and so refers to a polymer whose polymer chains comprise two or more different types of monomers. The skilled person will appreciate therefore that the term “co-polymer” encompasses polymers that include three different types of monomers (which can at times be referred to in the art specifically as “terpolymers”). The term “block co-polymer” takes its usual definition in the art and so refers to a copolymer whose polymer chains include two or more blocks of monomers. Each block is comprised of a particular monomer type, where at least two of the blocks present comprise a different monomer type to one another. A di-block co-polymer, a tri-block copolymer, and a tetra-block copolymer, each refer to copolymers with two, three, and four monomer blocks respectively.

As used herein, the term “monomer” takes its usual definition in the art and so refers to a molecular compound that may chemically bind to another monomer to form a polymer. Unless expressly stated to the contrary, any monomer referred to herein should be understood to include all enantiomers, diastereomers, racemates and mixtures thereof of the monomers in question.

It will be understood that the term “polymer backbone” refers to the series of covalently bonded atoms that create a continuous molecular chain which acts as a scaffold to which the functional groups are attached. In line with the usual definition in the art, the polymer backbone is generally the longest continuous molecular chain, to which other chains and functional groups may be regarded as being pendant.

It will be understood that the term “organic polymer backbone” refers to a polymer backbone that includes carbon-carbon covalent bonds.

The organic polymer backbone may be crosslinked or uncrosslinked. Preferably, the organic polymer backbone is crosslinked with a crosslinking agent such as divinylbenzene, hexamethylenetetramine, a functionalized silane, isocyanate, peroxide, or combinations thereof. More preferably, the organic polymer backbone is crosslinked with divinylbenzene. The amount of crosslinker can vary, but can be for example 1% to 50% by weight, based on the total weight of the polymer backbone and crosslinker.

The organic polymer backbone can for example be polystyrene, polyvinyl toluene, poly(vinylbenzyl chloride), polyvinyl acetate, polyvinyl butyral, polyvinyl ether, polyethylene, polyurethane, or acrylonitrile butadiene styrene.

Preferably, the organic polymer backbone is a vinyl polymer backbone, which will be understood as referring to a polymer backbone formed from vinyl monomers (i.e. those monomers including in their structure the formula —CH═CH₂). For example, the organic polymer backbone can be polystyrene, polyvinyl toluene, poly(vinylbenzyl chloride), polyvinyl acetate, polyvinyl butyral and polyvinyl ether. More preferably, the organic polymer backbone is polystyrene. In a particularly preferred embodiment, the organic polymer backbone is polystyrene crosslinked with divinylbenzene.

Disclosed herein, a series of functional groups are attached to the organic polymer backbone. It will be understood that this attachment is generally by covalent bonding to the organic polymer backbone. This attachment may be achieved by standard procedures known in the art. By “series” it is meant that there are a plurality of functional groups attached to the polymer backbone. For a given ion exchange resin, the functional groups may be the same or different.

The functional groups contain at least one heteroatom. The term “heteroatom” takes its usual definition in the art, and so refers to an atom that is not carbon or hydrogen. Preferably, the heteroatom is one or more of N (nitrogen), S (sulphur), O (oxygen), and P (phosphorus). More preferably, the heteroatom is one or more of N, S, and O, more preferably one or more of N and S. It will be appreciated that, when the heteroatom is one or more of the listed options, additional heteroatoms other than those recited in this list may also be present in the functional groups. Unless expressly stated to the contrary, the atomic species given for the heteroatom are to be understood as encompassing that species irrespective of whether or not it is in a neutral state. In particular, when the series of functional groups contain N, this encompasses scenarios where the N is positively charged, for example as part of a quaternary ammonium group.

Particularly preferred is when the series of functional groups includes one or more of an iminodiacetic acid group, a thiourea group, a quaternary ammonium group, a guanidine group, an amine group, and a thiol group. The skilled person will be familiar with the molecular structure implied by these groups. Within this embodiment, the functional groups of the series can be iminodiacetic acid groups, thiourea groups, quaternary ammonium groups, guanidine groups, amine groups, or thiol groups.

Even more preferably, the series of functional groups includes one or more of a thiourea group, a quaternary ammonium group, and a guanidine group. Within this embodiment, the functional groups of the series can be thiourea groups, quaternary ammonium groups or guanidine groups.

The functional groups disclosed herein can be attached to the polymer backbone by standard reaction procedures known in the art, with the attachment between the functional group and the backbone being located at an appropriate point of the molecular framework of the functional group, as will be appreciated by the skilled person.

The term “iminodiacetic acid” refers to the formula HN(CH₂CO₂H)₂.

When the series of functional groups includes an iminodiacetic acid group, the functional groups comprise one or more of the following moieties:

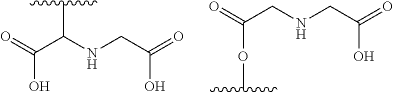 [SMILES: *C(NCC(=O)O)C(=O)O ; *OC(=O)CNCC(=O)O]

The term “thiourea” refers to the formula S═C(NR¹R²)(NR³R⁴), where R¹, R², R³ and R⁴ may be the same or different and are each independently selected from H or an alkyl group. Preferably, R¹, R², R³ and R⁴ are the same or different and are each independently selected from H or a C₁-C₅ alkyl group. Within this embodiment, R¹, R², R³ and R⁴ are the same or different and can each be independently selected from H or a C₁-C₃ alkyl group. More preferably, R³ and R⁴ are both H.

When the series of functional groups includes a thiourea group, the functional groups comprise one or more of the following moieties, with R¹, R², R³ and R⁴ taking the same meaning and preferences as those stated above:

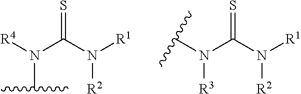

The term “quaternary ammonium” refers to the formula [NR⁵R⁶R⁷R⁸]+, where R⁵, R⁶, R⁷ and R⁸ may be the same or different and are each independently selected from H or an alkyl group. Preferably, R⁵, R⁶, R⁷ and R⁸ are the same or different and are each independently selected from H or a C₁-C₆ alkyl group. More preferably, R⁵, R⁶, R⁷ and R⁸ are each an alkyl group, preferably a C₁-C₆ alkyl group, and may be the same or different. Preferably, R⁵, R⁶, R⁷ and R⁸ are each a C₁-C₃ alkyl group, and may be the same or different.

When the series of functional groups includes a quaternary ammonium group, the functional groups comprise one or more of the following moieties, with R⁵, R⁶ and R⁷ taking the same meaning and preferences as those stated above:

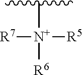

The term “guanidine” refers to the formula (R⁹R¹⁰N)(R¹¹R¹²N)C═N—R¹³ where R⁹, R¹⁰, R¹¹, R¹² and R¹³ may be the same or different and are each independently selected from H or an alkyl group. Preferably, the alkyl group is a C₁-C₆ alkyl group, more preferably a C₁-C₃ alkyl group. More preferably, the term “guanidine” refers to the formula HN═C(NH₂)₂, which the skilled person will appreciate is non-derivatised guanidine, where R⁹, R¹⁰, R¹¹, R¹² and R¹³ are each H.

When the series of functional groups includes a guanidine group, the functional groups comprise one or more of the following moieties, with R⁹, R¹⁰, R¹¹, R¹² and R¹³ taking the same meaning and preferences as those stated above:

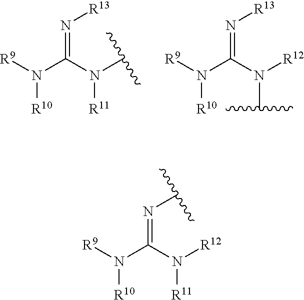

The term “thiol” refers to the formula R¹⁴—SH where R¹⁴ is an alkyl group, preferably a C₁-C₆ alkyl group, more preferably a C₁-C₃ alkyl group.

When the series of functional groups includes a thiol group, the functional groups comprise one or more of the following moieties:

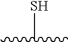 [SMILES: *S]

The term “amine” refers to the formula NR¹⁵R¹⁶R¹⁷, where R¹⁵, R¹⁶ and R¹⁷ may be the same or different and are each independently selected from H or an alkyl group. Preferably, R¹⁵, R¹⁶ and R¹⁷ are the same or different and are each independently selected from H or a C₁-C₆ alkyl group. More preferably, R¹⁵R¹⁶ and R¹⁷ are the same or different and are each an alkyl group, preferably a C₁-C₆ alkyl group. Preferably, R¹⁵, R¹⁶ and R¹⁷ are each a C₁-C₃ alkyl group, and may be the same or different.

When the series of functional groups includes an amine group, the functional groups comprise one or more of the following moieties, with R¹⁵ and R¹⁶ taking the same meaning and preferences as those stated above:

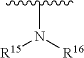

As used throughout, it will be understood that the symbol “ [symbol] ” denotes the end of the molecular fragment and so refers to the point at which the moieties are attached to the polymer backbone. The moieties may be attached directly to the polymer backbone e.g. by way of a direct bond, or, they may be attached via an alkyl group, such as a C₁-C₁₀ alkyl group, preferably a C₁-C₆ alkyl group, more preferably a C₁-C₃ alkyl group.

As used herein, the term “alkyl” refers to a straight or branched saturated or unsaturated alkyl group. Preferably, the alkyl group is a saturated alkyl group. More preferably, the alkyl group is a straight alkyl group. As used herein, the term “(Cₐ-C_{b})alkyl” wherein a and b are integers refers to a straight or branched chain alkyl having from a to b carbon atoms. Thus, by way of example, a C₁-C₁₀ alkyl group refers to a group having from 1 to 10 carbon atoms, and so includes methyl, ethyl, n-propyl, isopropyl, n-butyl, isobutyl, sec-butyl, t-butyl, n-pentyl, n-hexyl, heptyl, octyl, nonyl and decyl. Meanwhile, a C₁-C alkyl group refers to a group having from 1 to 6 carbon atoms, and so includes methyl, ethyl, n-propyl, isopropyl, n-butyl, isobutyl, sec-butyl, t-butyl, n-pentyl, n-hexyl.

The resin may be provided as a plurality of beads with a particle size distribution such that more than 95% of the particles have a diameter of 0.1 to 10 mm, 0.2 to 5 mm, 0.1 to 2.5 mm or 0.2 to 1.5 mm. The bulk density can vary, for example from 100 g/l to 2000 g/l, preferably from 200 to 900 g/l, more preferably from 500 g/l to 900 g/l, or from 600 g/l to 850 g/l. The absolute density can vary, for example from 100 to 2000 g/l, preferably from 200 to 1500, more preferably from 500 to 1200 g/l.

When resins feature in the process disclosed herein, the process may further comprise the step of recovering the lithium species (i.e. the lithium halide, and/or the other form(s) of lithium to which the lithium halide has been converted) from the lithium species resin complex. The skilled person will appreciate that this can be carried out by a variety of possible means. For example, the resin, complete with the complexed lithium species (the lithium species resin complex) can be removed from the remaining components of the process disclosed herein by appropriate solid-liquid separation techniques (such as sieving, for example), before subjecting the resin to a suitable process to separate the lithium species from the resin. For example, the lithium species can be recovered from the lithium species resin complex by stripping, incineration, ashing or burning of the resin.

The process disclosed herein may comprise the additional step of subjecting the material from which the lithium has been extracted to a decontamination step, said decontamination step comprising the step of contacting the material with one or more ion exchange resins with specifics and preferred features disclosed herein. It has been found that certain functional groups, such as thiol groups, have selectivity for impurities such as arsenic, mercury, and lead. Therefore, not only can certain resins disclosed herein be used to selectively extract lithium in preference to impurities, but certain resins disclosed herein can then be used to decontaminate the material leftover from the process (sometimes referred to as “tailings”), providing a “clean up” operation for the tailings leftover from the process.

The following non-limiting examples illustrate the invention.

### Example 1

To 750 ml of water, 70 gm of sodium bromide was added with agitation at room temperature, 40 ml of 50% hydrogen peroxide was added and the reaction stirred for 5 min. Sulfuric acid (conc) was added to reduce the pH to 0.5 and the reaction stirred for 30 min whereby the reaction turned from colorless to a light yellow. Crushed ore (400 gm) (the “head ore”) was added and the reaction stirred for 5 min and then filtered. The tails (i.e. spent ore material left over after the lithium has been extracted) were washed separately and both heads and tails were analyzed using ICP (inductively coupled plasma) for lithium and, for comparison purposes, gold, with the following results.

| | Gold | Lithium |
|---|---|---|
| Head Ore | 2.07 ppm | 8.5 ppm |
| Tailings ore after | 1.97 ppm | 5.2 ppm |
| extraction | | |
| Yield | 4.8% | 39% |

The level of lithium extraction can be assessed by comparing the level of lithium in the head ore to the level of lithium remaining in the tails. The bigger the difference between the level of lithium in the head ore and the level of lithium remaining in the tails, the better the lithium extraction As can be seen from the following results, the lithium was successfully extracted providing higher yields than those obtained for e.g. gold extraction.

The reaction was then repeated and run for 1 h giving gold extraction of 90% and lithium extraction of 98%.

### Example 2

To 750 ml of water, 70 gm of potassium iodide was added with agitation at room temperature, 40 ml of 50% sodium hypochlorite were added and the reaction stirred for 15 min. Crushed ore (400 gm) was added and the reaction stirred for 60 min and then filtered. The tails were washed separately and both heads and tails were analyzed using ICP for both gold and lithium giving similar results as in example 1.

### Example 3

To 750 ml of water, 70 gm of sodium chloride, 5 gm of sodium bromide was added with agitation at room temperature, 40 ml of 50% sodium hypochlorite were added and the reaction stirred for 15 min. Crushed ore (400 gm) was added and the reaction stirred for 120 min and then filtered. The tails were washed separately and both heads and tails were analyzed using ICP for both gold and lithium giving similar results as in example 1.

### Example 4

To 750 ml of water, 70 gm of potassium bromide was added with agitation at room temperature, and ozone generated by a laboratory generator was bubbled through the solution until the solution had a light yellow color which took approximately 45 min. Crushed ore (400 gm) was added and the reaction stirred for 60 min and then filtered. The tails were washed separately and both heads and tails were analyzed using ICP for both gold and lithium.

### Example 5

To 750 ml of water, 70 gm of sodium bromide was added with agitation at room temperature, 40 ml of 50% hydrogen peroxide were added and the reaction stirred for 5 min. Sulfuric acid (conc) was added to reduce the pH to 0.5 and the reaction stirred for 30 min whereby the reaction turned from colorless to a light yellow. Crushed ore (400 gm) was added and the reaction stirred for 5 min and then filtered. The tails were washed separately and both heads and tails were analyzed using ICP for both gold and lithium.

### Example 6

To 750 ml of water, 70 gm of sodium chloride was added with agitation at room temperature, hydrochloric acid was added until the solution reached pH1 and then chlorine gas was bubbled through the solution. The tails were washed separately and both heads and tails were analyzed using ICP for lithium.

### Example 7

To a stirred solution of water (170 ml), 20 ml of 46% sodium bromide was added together with 10 ml of hydrogen peroxide (35%) and the reaction taken to pH 0.5 by the addition of concentrated nitric acid (2.4 ml). The lixiviant was stirred for 30 min and 50 gm and at this stage the ORP had risen from 480 to 785 vs a silver electrode. Crushed ore containing a lithium salt/mineral (50 gm) was added in a crushed form (approximately 75 micron) and the mixture bottle rolled for 90 min. The pH was 0.68 and the ORP was 775 at the end of the reaction. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 112.3 gm of extracted lithium per ton of lithium bearing material.

### Example 8

To a stirred solution of water (180 ml), 10 ml of 46% sodium bromide, sodium chloride (10 gm) was added together with 10 ml of hydrogen peroxide (35%) and the reaction taken to pH 0.5 by the addition of concentrated sulfuric acid (2.4 ml). The lixiviant was stirred for 30 min and at this stage the ORP had risen from 480 to 795 vs a silver electrode. Crushed ore containing a lithium salt/mineral (50 gm) was added in a crushed form (approximately 75 micron) and the mixture bottle rolled for 60 min. The final pH was 0.57 and the ORP was 777. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 113 gm of extracted lithium per ton of lithium bearing material.

### Example 9

To a stirred solution of water (175 ml), 10 gm of potassium iodide was added together with 10 ml of sodium hypochlorite (11%) and the lixiviant was stirred for 30 min and 50 gm and at this stage the ORP was 315 and the pH 11.5 vs a silver electrode. Crushed ore containing a lithium salt/mineral (50 gm) was added in a crushed form (approximately 75 micron) and the mixture bottle rolled for 60 min. The pH was 10.4 and the ORP 314 at the end of the reaction. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 76 gm of extracted lithium per ton of lithium bearing material.

### Example 10

To a stirred solution of water (180 ml), 20 ml of 46% sodium bromide was added together a sodium chloride electric cell for 60 seconds. The cell was removed and the ORP was measured at 760 but declined rapidly back to 580. Sulfuric acid was added and the ORP raised immediately to 780 without the need to add electricity. The liquid was subjected to further electrolysis and the ORP rose modestly to 805 and the lixiviant was stirred for 30 min. Crushed ore containing a lithium salt/mineral (50 gm) was added in a crushed form (approximately 75 micron) and the mixture bottle rolled for 60 min. The ORP was 800 and the pH 0.61. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 113 gm of extracted lithium per ton of lithium bearing material.

### Example 11

To a stirred solution of water (175 ml), 10 ml of 46% sodium bromide solution in water was added together with 10 ml of sodium hypochlorite (11%), the lixiviant brought down to pH 0.5 using concn sulfuric acid (2 ml) and the lixiviant was stirred for 30 min the ORP was 850 and the pH 0.5 vs a silver electrode. Crushed ore containing a lithium salt/mineral (50 gm) was added in a crushed form (approximately 75 micron) and the mixture bottle rolled for 90 min. The ORP was 845 and the pH was 0.65. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 113 gm of extracted lithium per ton of lithium bearing material.

### Example 12

To a stirred solution of water (175 ml), 10 gm of sodium chloride was added together with 15 ml of sodium hypochlorite (11%), and the pH reduced to pH 0.5 using hydrochloric acid and the lixiviant was stirred for 30 min and at this stage the ORP was 1150 and the pH 0.5 vs a silver electrode. Crushed ore containing a lithium salt/mineral (50 gm) was added in a crushed form (approximately 75 micron) and the mixture bottle rolled for 90 min. The ORP was 1129 and the pH was 0.63. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 111 gm of extracted lithium per ton of lithium bearing material.

### Example 13

To a stirred solution of water (175 ml), 10 gm of potassium iodide, sodium bromide 10 ml of 46% solution was added together with 10 ml of sodium hypochlorite and the lixiviant and the pH was reduced to 0.5 using sulfuric acid (2 ml) was stirred for 30 min and at this stage the ORP was 345 and the pH 0.5 vs a silver electrode. Crushed ore containing a lithium salt/mineral (50 gm) was added in a crushed form (approximately 75 micron) and the mixture bottle rolled for 90 min. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 111 gm of extracted lithium per ton of lithium bearing material.

### Example 14

To a stirred solution of water (180 ml), 20 ml of 46% sodium chloride was added together a sodium chloride electric cell for 60 seconds. The cell was removed and the ORP was measured at 480 but declined rapidly back to 580.

Hydrochloric acid was added to pH 0.5 and the ORP raised immediately to 1180 without the need to add electricity. Crushed ore containing a lithium salt/mineral (50 gm) was added in a crushed form (approximately 75 micron) and the mixture bottle rolled for 90 min. The ORP was 495 and the pH 0.56.

The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 110 gm of extracted lithium per ton of lithium bearing material.

### Example 15

To a stirred solution of water (180 ml), 10 gm of potassium iodide was added together a sodium chloride electric cell for 60 seconds. The cell was removed and the ORP was measured at 320 and the pH at 11.94. Additional electricity did not increase the ORP. Crushed ore containing a lithium salt/mineral (50 gm) was added in a crushed form (approximately 75 micron) and the mixture bottle rolled for 90 min. The ORP was 305. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 69 gm of extracted lithium per ton of lithium bearing material.

### Example 16

To a stirred solution of water (170 ml), 20 ml of 46% sodium bromide was added together with 10 ml of hydrogen peroxide (35%) and the reaction taken to pH 3.0 by the addition of concentrated sulfuric acid (2.4 ml) and the ORP was 530. The lixiviant was stirred for 30 min and 50 gm and at this stage the ORP had risen from 480 to 785 vs a silver electrode. Crushed ore containing a lithium salt/mineral (50 gm) was added in a crushed form (approximately 75 micron) and the mixture bottle rolled for 90 min. The pH was 5.3 and the ORP was 354 at the end of the reaction. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 86.83 gm of extracted lithium per ton of lithium bearing material.

### Example 17

To a stirred solution of water (180 ml), 10 ml of 46% sodium bromide, sodium chloride (10 gm) was added together with 10 ml of hydrogen peroxide (35%) and the reaction taken to pH 3.0 by the addition of concentrated sulfuric acid (2.4 ml). The lixiviant was stirred for 30 min and at this stage the ORP had risen from 480 to 865 vs a silver electrode. Crushed ore containing a lithium salt/mineral (50 gm) was added in a crushed form (approximately 75 micron) and the mixture bottle rolled for 60 min. The final pH was 0.57 and the ORP was 777. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 96.43 gm of extracted lithium per ton of lithium bearing material.

### Example 18

To a stirred solution of water (180 ml), 10 gm of potassium iodide was added together a sodium chloride electric cell for 60 seconds. The cell was removed and the ORP was measured at 330. The pH was reduced to pH 0.5 using sulfuric acid and the Crushed ore containing a lithium salt/mineral (50 gm) was added in a crushed form (approximately 75 micron) and the mixture bottle rolled for 90 min. The reaction was filtered and the filtrate sampled for testing and removed from the buchner filter and the ore was washed and a sample of the washing retained for analysis by ICP. The washed tails were dried in an oven and sent for analysis. The ICP analysis on the solution gave 118 gm of extracted lithium per ton of lithium bearing material.

1. A method of extracting lithium from a lithium bearing material comprising the steps of:
a) providing an aqueous oxidant mixture comprising water, an oxidising means, and a source of halide ion,
b) contacting the aqueous oxidant mixture with the lithium bearing material to extract the lithium from the lithium bearing material and form a lithium halide solution.

2. The method of claim 1, wherein the oxidising means is hydrogen peroxide, ozone, oxygen, chlorine, bromine, iodine, hypochlorous acid, hypobromous acid, hypoiodous acid, a hypochlorite salt, a hypobromite salt, a hypoiodite salt, a permanganate salt, an anode connected to a power source, or a combination thereof.

3. The method of any preceding claim wherein the oxidising means is hydrogen peroxide, oxygen, ozone, chlorine, hypochlorous acid, hypobromous acid, a hypochlorite salt, a hypobromite salt, a hypoiodite salt, a permanganate salt, or a combination thereof.

4. The method of any preceding claim, wherein the oxidising means is hydrogen peroxide.

5. The method of any preceding claim, wherein the source of halide ion is a source of bromide ion, a source of chloride ion, a source of iodide ion, or a combination thereof.

6. The method of any preceding claim, wherein the source of halide ion is a source of bromide ion, a source of chloride ion, or a combination thereof.

7. The method of any preceding claim, wherein the source of halide ion is at least one metal halide, said metal being lithium, potassium, sodium, calcium, or a combination thereof.

8. The method of any preceding claim, wherein the source of halide ion is at least one alkali metal halide, said alkali metal being lithium, potassium, sodium, or a combination thereof.

9. The method of any preceding claim, wherein the aqueous oxidant mixture has a pH of 0-7, preferably 0-6, more preferably 0.8 to 6.

10. The method of any preceding claim, wherein the aqueous oxidant mixture has a pH of 0.1 to 5.

11. The method of any preceding claim, wherein the aqueous oxidant mixture further comprises an acid, said acid preferably being sulphuric acid, nitric acid, hydrochloric acid, acetic acid, carbonic acid, formic acid, or a combination thereof.

12. The method of any preceding claim, wherein the aqueous oxidant mixture has a pH of 7-14, preferably 8-14.

13. The method of any preceding claim, wherein the aqueous oxidant mixture further comprises an alkaline material, said alkaline material preferably being sodium hydroxide, potassium hydroxide, calcium carbonate, calcium bicarbonate, sodium carbonate, sodium bicarbonate, potassium carbonate, potassium bicarbonate, calcium oxide, sodium hypochlorite, potassium hypochlorite, or a combination thereof.

14. The method of any preceding claim, further comprising the step of:
c) converting the lithium halide to lithium metal, lithium carbonate, and/or lithium hydroxide.

15. The method of claim 14, wherein step c) comprises the step of contacting the lithium halide solution with carbon dioxide, carbon monoxide, sodium carbonate, potassium carbonate, sodium bicarbonate, potassium bicarbonate, carbonic acid, a reducing means (such as zinc, sodium metabisulfite, hydrogen gas, and/or a cathode connected to a power source), sodium hydroxide, potassium hydroxide, oxygen, ozone, or a combination thereof.

16. The method of any one of claims 14-15, wherein step c) comprises the step of contacting the lithium halide solution with carbon dioxide, carbon monoxide, sodium carbonate, potassium carbonate, sodium bicarbonate, potassium bicarbonate, carbonic acid, or a combination thereof, thereby converting the lithium halide to lithium carbonate.

17. The method of any one of claims 14-16, wherein step c) comprises the step of contacting the lithium halide solution with a reducing means (such as zinc, sodium metabisulfite, hydrogen gas, and/or a cathode connected to a power source), thereby converting the lithium halide to lithium metal.

18. The method of any one of claims 14-17, wherein step c) comprises the step of contacting the lithium halide solution with sodium hydroxide, potassium hydroxide, oxygen, ozone, or a combination thereof, thereby converting the lithium halide to lithium hydroxide.

19. The method of any one of claims 1-13, further comprising the step of recovering the lithium halide.

20. The method of any one of claims 14-18, further comprising the step of recovering the lithium metal, lithium carbonate, and/or lithium hydroxide.

21. The method of any preceding claim, wherein step b further comprises contacting the aqueous oxidant mixture with a resin, said resin being an ion exchange resin comprised of an organic polymer backbone to which a series of functional groups are attached, said functional groups containing at least one heteroatom.

22. The method of any preceding claim, wherein step c further comprises contacting the lithium halide solution with a resin, said resin being an ion exchange resin comprised of an organic polymer backbone to which a series of functional groups are attached, said functional groups containing at least one heteroatom.

23. The method of any one of claims 14-22, wherein step c further comprises contacting the lithium metal, lithium carbonate, and/or lithium hydroxide with a resin, said resin being an ion exchange resin comprised of an organic polymer backbone to which a series of functional groups are attached, said functional groups containing at least one heteroatom.

24. The method of any preceding claim, wherein the lithium bearing material is an ore, a subsurface brine, a lithium battery, or a combination thereof.

25. The method of any preceding claim, wherein the lithium bearing material is an ore.

26. The method of any preceding claim, wherein the lithium bearing material is a lithium battery.
